(19) United States
(12) Patent Application Publication
(10) Pub. No.: US 2012/0271747 A1
(43) Pub. Date: Oct. 25, 2012

(54) Methods, Apparatus, and Systems for a Global Equity Exchange

(75) Inventor: Robert Krause, Gillette, NJ (US)

(73) Assignee: VOLATILITY PARTNERS, LLC, Gillette, NJ (US)

(21) Appl. No.: 13/228,577

(22) Filed: Sep. 9, 2011

Related U.S. Application Data
(60) Provisional application No. 61/477,070, filed on Apr. 19, 2011.

(51) Int. Cl. G06Q 40/00

(52) U.S. Cl. 705/37

(57) ABSTRACT

Systems, software, financial exchanges, and methods for a new global finical exchange are described. In one aspect, the present invention provides an exchange that lists sector, country, regional, and world electronically traded electronic representations of instruments on a set of representative global equity indices based on a single source, on an electronic exchange, open nearly 24-hours every business day, in one base currency, with periodic (annual) normalized index prices, utilizing a unique share-sized derivatives instrument as described in U.S. patent application Ser. No. 13/074,687, having cross margining, yearly expirations, associated options, and realized volatility instruments. All of these features combined into one comprehensive package will attract market participants because of a better-designed product, utilizing capital in the most efficient way possible, with features not found, or not commonly found, on any exchange, and with many cost-saving elements. The present invention could be the first credible threat to the dominance of the handful of mega exchanges in the U.S. and Europe.

### 1 BACKGROUND OF THE INVENTION

1.1 Field of the Invention

The present invention relates to the introduction, generation, and trading of indices, especially equity indices, and more particularly to the generation, introduction, and trading of new types of financial instruments on global markets. The present invention has applications in the fields of business methods and finance, and the application of computer and communications technologies to those fields.

1.2 The Related Art

The various equity indices around the world reflect a wide variety of designs and methodologies having unique strengths and weaknesses. Perhaps the oldest and best known index is the Dow Jones Industrial Average (“DJIA” or the “Dow”). The Dow is determined by the averaged prices of 30 “industrial” stocks, making the Dow a “price-weighted” index. An advantage to the Dow's design is that the index can give a helpful indication of the market's desire to hold equities generally, which can be a useful reflection of various economic factors. One drawback to the Dow's price-weighting methodology, however, is that higher-priced stocks contribute more to the index than lower-priced stocks; and that higher-priced stocks are subject to various manipulations that have no reflection on the fundamental economics of the company or the market in general, making changes in the index potentially misleading. For example, a company can affect the index to a greater or lesser degree by going through a reverse stock split or stock split; yet the economics of the company are no different in either event. Thus, the performance of the Dow can be affected greatly by actions that have no fundamental economic significance.

The German DAX index, on the other hand, is designed to function as a so-called “total return index”: all the dividends issued by the component companies are added into the index, thus giving investors a representation of the total income received by a typical investor in the stocks that compose the index. While it can be argued that such a method is “better” that the Dow's methodology, there are still other indices that do not add the dividends back into the index, such as the well known Standard and Poor's (“S&P”) 500 stock index in the U.S. Still other indices are broad-based, such as the Russell 2000, which contains 2,000 smaller-capitalization stocks in the U.S. Yet other indices are narrow-based, such as the STOXX 50 index in Europe, which uses only 50 stocks to represent the performance of the entire region of Europe. The Brazilian Bovespa index is dominated by only two stocks.

The most followed benchmarks in the world are provided by MSCI (New York, N.Y.), which provides country, regional, and global indices in real time, and even offers other sub-indices such as sectors and market capitalization. Many international portfolio managers use MSCI to gauge the performance of their portfolios. However, even though MSCI has licensed their indices to various exchanges no one has thought of providing derivatives tied to MSCI's whole array of indices on one platform using a single methodology.

Other index providers, such as Financial Times, Standard and Poor's, Dow Jones, NASDAQ, and Russell, have created various country, regional, sector, and other specialty indices. Like MSCI, these companies could also supply the consistent methodology that would be a key ingredient in making a single global equity exchange a reality, but none has demonstrated any significant activity towards such an exchange.

In addition to a variety of indices and benchmarks, investors also have traded on a variety of exchanges determined by asset classes. For example, the Chicago Board of Trade (“CBOT”) was typically referred to as “the grain exchange” because it listed crops, such as wheat, corn, oats, and soybeans. The Chicago Mercantile Exchange (“CME”) listed livestock, such as cattle, hogs, and broiler chickens. The New York Mercantile Exchange (“NYMEX”) listed energy products such as crude oil, heating oil, gasoline, and natural gas. The Commodities Exchange in New York (“COMEX”) was known for listing of precious metal futures, such as gold, silver, and platinum.

Over time, however, the division of exchanges along strict asset lines became blurred, as the futures exchanges started listing non-commodities. For example, the CBOT began listing treasury bonds, and the CME listed S&P 500 index futures. It also became clear over time that economies of scale could be achieved if the large number of exchanges could consolidate, thereby saving redundant exchange staff costs, allow for cross margining (saving traders the cost of using excess capital), and reducing marketing costs, among other savings. To that end, the CME purchased the CBOT, NYMEX, and COMEX. Still other exchange merger announcements have followed, with the German exchange Eurex placing a bid for the New York Stock Exchange; the London Exchange trying to merge with the Toronto Exchange; and the Singapore exchange trying to merge with the Australian exchange. Whether these mergers are successful or not, the trend is clear that large economies of scale can occur by exchanges merging.

Yet as this consolidation trend continues it is becoming harder to launch a new exchange. A new small exchange lacks the resources, income, and economies of scale necessary to compete with today's existing large entities. The only way smaller exchanges can compete is by offering unique investment products protected by intellectual property. Another disadvantage to any exchange, large or small, is the very hard time launching new instruments, because it is very costly for all market participants to begin trading in a new instrument: the exchange pays a lot of money upfront in development and marketing costs; market-makers make little if any income from the endeavor in its initial stages; brokers and system developers have few initial customers clamoring for a new product; and end users find that large bid-ask spreads and small sizes are common with any new instrument which increases transaction costs. In short, then, it is much easier for exchanges to consolidate and cut the costs of trading existing products than to go through the expense and high failure rate of launching new instruments.

In other words, highly liquid instruments traded on a large cost-efficient exchange will garner the lion's share of market participation, even when those instruments are not a good fit for participants' needs. They do this because the cost savings from deep liquidity offsets the cost of a mismatch hedge. In order to make a new product successful, it needs to bring down the total costs below the cost of transacting in existing liquid instruments. Given the market power of existing consolidated exchanges, this presents a monumental task.

Thus, there is a need for an exchange that provides the advantages of a consistent global equity exchange and allows for the efficient trading of new instruments. In particular, to overcome the very difficult task of launching a new instrument, there must be a variety of cost savings to compete with the cost savings of highly liquid products and consolidated exchanges. However, lower costs are not enough; there also must be new features that bring in market participants who are not served by the current instruments. The present invention meets these and other needs.

### 2 SUMMARY OF THE INVENTION

The present invention provides systems, software, and methods for a new global financial exchange. In one aspect, the present invention provides an exchange that lists electronically traded electronic representations of instruments on a set of representative global equity indices based on a single source, on an electronic exchange, open nearly 24-hours every business day, in one base currency, with periodic (annual) normalized index prices, utilizing unique share-sized derivatives instruments, having cross margining, yearly expirations, associated options, and realized volatility instruments. All of these features combined into one comprehensive package will attract market participants because of a better-designed product, utilizing capital in the most efficient way possible, with features not found, or not commonly found, on any exchange, and with many cost-saving elements. The present invention could be the first credible threat to the dominance of the handful of mega exchanges in the U.S. and Europe.

In a first aspect, the present invention provides a computer-implemented financial exchange. In one embodiment, the computer-implemented financial exchange comprises a plurality of computers in electronic communication; the computers are configured to provide electronically users of the computer-implemented financial exchange with instruments on electronically traded electronic representations of instruments on a set of representative global equity indices based on a single source. The computer-implemented financial exchange is further configured to provide electronically exchange operations substantially continuously.

In another embodiment, the computer-implemented financial exchange of the invention as first described is further configured to provide electronically the above-described instruments in share-sized units. In another embodiments, the instruments are traded at a normalized price. In a more specific embodiment, the normalized price is revised yearly.

In another embodiment, the computer-implemented financial exchange of the invention as first described is configured to conduct electronically the trades using a single base currency.

In another embodiment, the computer-implemented financial exchange of the invention as first described is configured to conduct electronically the trades using a single base currency and to provide electronically above-described instruments in share-sized units. In another embodiments, the instruments are traded at a normalized price. In a more particular embodiment, the associated option or realized volatility instruments, or both are VALSHARES®, VOLSHARES® and VOLCONTRACT® instruments.

In a second aspect, the present invention provides a computer-implemented method for operating a computer-implemented financial exchange. In one embodiment, the method provided by the invention comprises providing a plurality of computers in electronic communication, the computers providing electronically users of the computer-implemented financial exchange with indices from a single source; and the computers providing electronically operations for the computer-implemented financial exchange substantially continuously.

In a more particular embodiment, the method further comprises providing electronically the above-described instruments in share-sized units. In another embodiment, the above-described instruments are traded using a normalized price. In still more particular embodiment, the method further comprises providing electronically associated option or realized volatility instruments, or both; in yet more particular embodiments, the instruments are VALSHARES®, VOLSHARES® and VOLCONTRACT® instruments.

In some other embodiments, the computer-implemented method of the invention further comprises normalizing the price periodically, and, in more particular embodiments, normalizing the price yearly. In still other embodiments, the method of the invention further comprises receiving electronically information related to trades of the above-described instruments listed on the exchange; sending electronically information related to trades of the above-described instruments listed on the exchange; receiving electronically information related to the indexes; and sending electronically information related to the indexes.

In some embodiments, the computer-implemented method of the invention as first described further comprises conducting electronically the trades using a single base currency.

In some embodiments, the computer-implemented method of the invention as first described further comprises conducting electronically the trades using a single base currency and providing electronically above-described instruments in share-sized units. In still another embodiments, the instruments are traded using a normalized price. In still other embodiments, the above-described instruments include associated option or realized volatility instruments, or both.

In a third aspect, the present invention provides an electronic computer configured to operate on a computer-implemented financial exchange in electronic communication therewith. In one embodiment, the electronic computer comprises electronic instructions and data configured to provide users of the computer-implemented financial exchange with indexes from a single source, and allow electronic trading on the computer-implemented financial exchange substantially continuously.

In a more particular embodiment, the electronic instructions and data include electronic instructions and data encoding the above-described share-sized instruments. In another embodiment the electronic instructions and data are configured to enable electronic trading of the above-described instruments using a normalized price. In a more particular embodiment, the electronic instructions and data for the above-described instruments includes electronic instructions and data encoding associated option or realized volatility instruments, or both; in more particular embodiments, the associated option or realized volatility instruments, or both are VALSHARES®, VOLSHARES® and VOLCONTRACT® instruments.

In some embodiments, the aforementioned normalized price is a periodically revised normalized price; in more specific embodiments, the normalized price is a yearly revised normalized price.

In other embodiments, the electronic instructions and data further include electronic instructions and data configured to enable the electronic computer to conduct electronically the trades using a single base currency.

In still other embodiments, the electronic instructions and data further include electronic instructions and data configured to enable the electronic computer to conduct electronically the electronic trading using a single base currency, to provide electronically above-described instruments in share-sized units. In still other embodiments, the instruments are traded at a normalized price. In yet other embodiments, the above-described instruments include associated option or realized volatility instruments, or both and the normalized price is revised periodically.

In a fourth aspect, the present invention provides a computer-readable medium containing computer-readable electronic program control devices thereon, comprising: computer-readable electronic program control devices configured to enable an electronic computer to operate on a computer-implemented financial exchange in electronic communication with such exchange, and computer-readable electronic program control devices encoding electronic instructions and data configured to provide users of the computer with indexes from a single source, and allow electronic trading using the computer on the computer-implemented exchange substantially continuously.

In more particular embodiments, the electronic instructions and data include electronic instructions and data encoding share-sized above-described instruments. In other embodiments, the electronic instructions and data are further configured to enable electronic trading of the above-described instruments using a normalized price. In still more particular embodiments, the electronic instructions and data for the above-described instruments includes electronic instructions and data encoding associated option or realized volatility instruments, or both; in more particular embodiments, the associated option or realized volatility instruments, or both are VALSHARES®, VOLSHARES® and VOLCONTRACT® instruments.

In other embodiments, the normalized price is a periodically revised normalized price; and in more specific embodiments, the normalized price is a yearly revised normalized price. In still other embodiments, the electronic instructions and data further include electronic instructions and data configured to enable the electronic computer to conduct electronically the trades using a single base currency.

In some embodiments, the electronic instructions and data described originally further include electronic instructions and data configured to enable the electronic computer to conduct electronically the electronic trading using a single base currency, to provide electronically above-described instruments in share-sized units. In other embodiments, the instruments are traded at a normalized price. In yet other embodiments, the above-described instruments include associated option or realized volatility instruments, or both.

These and other important aspects and advantages will become apparent when the following Detailed Description is read.

### 3 DETAILED DESCRIPTION OF SOME EMBODIMENTS OF THE INVENTION

### 3.1 A World Index Exchange

The present invention provides methods, systems, and apparatus for an exchange (referred to herein as “The World Index Exchange” or “WIX”) that is capable of launching new products at reduced costs compared to existing exchanges and products. As will be understood by those having ordinary skill in the art, the present invention will enable product offerings so compelling, so cost effective, so feature rich, that market participants will see immediately the benefits of the invention. Although there are many combinations of ways to implement the details of the present invention, a preferred embodiment is one in which all features and cost-saving measures described herein are implemented together.

As used herein unless otherwise indicated, “exchange” refers to a marketplace in which certain securities, commodities, derivatives and other financial instruments are purchased and traded, such that those instruments are cleared at a central clearing house as opposed to bilateral agreements, which are not cleared but subject to the credit risk of the two parties involved. The exchange may be a regulated exchange or an unregulated exchange, as will be understood by those having ordinary skill in the art. The core functions of an exchange include providing a mechanism that ensures fair and orderly trading in such financial instruments, an efficient dissemination of price information for those financial instruments, and a central clearing house to handle the collateral and the movement of funds between or among entities. Exchanges have physical structures, such as the New York Stock Exchange, or electronic-only formats, such as BATS. The latter is referred generally herein either as an “electronic exchange” or a “computer-implemented exchange.” Relevant examples of computer-implemented exchanges include electronic trading platforms and electronic communications networks. The structure and function of exchanges and, in particular, electronic exchanges, will be familiar to those having ordinary skill in the art.

As used herein unless otherwise indicated, “instrument” or “financial instrument” refers to a real or virtual (i.e., an electronic representation stored in a computer memory device, usually, although not necessarily, in communication with an electronic data processor) document representing a legally enforceable agreement having some sort of actual or notional monetary value and is potentially tradable. In general, financial instruments can be considered tradable packages of value. A financial instrument can be classified generally as an asset itself or as a derivative on an asset. Examples of financial instruments that are assets are: equity, debt, and foreign exchange. Examples of financial instruments that are derivatives are: futures on a commodity, options on an index, and over-the-counter swaps on an interest rate. The terms “instrument” and “financial instrument” as used herein also include instruments on indices, and more particularly equity indices (real or virtual as defined above). All instrument types have a variety of categories and subcategories as will be familiar to those having ordinary skill in the art.

In more particular embodiments, the instruments and other information necessary to the operation of the WIX and other aspects of the invention are provided in the form of representational electronic data structures, which electronic data structures are stored in suitable memory devices as described below. The memory holding the data structures communicates with computer data processors which operate on the data according to processes that are also encoded in memory coupled with the data processors. The data and processors may be part of the same device or on two or more different devices that are in electronic communication; typically many such devices are connected by communications links sending encoded representation of data among such devices to form electronic networks. Such networks can process millions even billions of transactions daily, far beyond what any individual human operator or group of human operators could conceivably accomplish. Thus, the present invention requires the computer data structures, memory and processors, and networks described herein to function; these devices cannot be replaced by human activities in any meaningful manner.

Thus, the present invention includes electronic data structures representing the instruments and other information described herein. The present invention also includes the memory devices that hold the data structures. The present invention further includes memory holding the processes used to transform the data structures into new data structures that are also stored in the memory devices as needed to accomplish the operations of the invention as described herein and understood by those having ordinary skill in the art. The invention further includes the combinations of memory devices holding the data structures as described herein in combination with data processors as described herein that are configured to transform the data structures into new data structures and stored in the memory devices. In addition, the present invention further includes the electronic networks including the processors and memory devices described herein.

In a first aspect, the present invention provides a computer-implemented financial exchange. In one embodiment, the computer-implemented method of the invention includes a plurality of computers in electronic communication. The computers are configured to provide electronically the users of the computer-implemented financial exchange with instruments on electronic representations of instruments on a set of representative global equity indices based on a single source. As used herein, “a set of representative global equity indices based on a single source” refers to a set of indices, defined below, prepared and maintained by a provider of indices that meets two necessary criteria: (a) they provide country indices based on stocks in developed countries; and (b) they use consistent methodology for assembling their indices regardless of the specific index. In addition to the foregoing, one or more of the following types of optional attributes can be considered “single source”: (a) they provide country indices based on stocks in emerging market countries; (b) they provide regional indices that are comprised of groups of countries (such as Europe, Asia, North America, etc.); (c) they provide economic indices that are comprised of groups of developed or emerging markets, or both; (d) they provide sector indices that are based on type of business (such as financials, industrials, services, etc.); or (e) their indices are based on methodologies having desirable attributes, such as being diversified and market capital-weighted. The set of representative global equity indices includes those indices that provide investors a standard measure of global equity activity. In one embodiment, the set of representative global equity indices is based on the six largest, most developed markets in the world; in a more specific embodiment, the six are: the United States, Germany, France, U.K., Japan, and Hong Kong. In another embodiment, the set just described further includes all developed markets; in a more specific embodiment, those markets include Australia, Austria, Belgium, Canada, Denmark, Finland, France, Germany, Greece, Hong Kong, Ireland, Italy, Japan, Netherlands, New Zealand, Norway, Portugal, Singapore, Spain, Sweden, Switzerland, United Kingdom, and the United States. In still another embodiment, the set of representative global equity indices further includes, in addition to at least the first six mentioned above, indices on emerging markets; in a more specific embodiment, those markets include, China, India, Indonesia, Korea, Malaysia, Pakistan, Philippines, Taiwan, Thailand, Argentina, Brazil, Chile, Colombia, Mexico, Peru, Venezuela, Czech Republic, Egypt, Hungary, Israel, Jordan, Morocco, Poland, Russia, South Africa, and Turkey.

In yet another embodiment, the set further includes, in addition to any of the foregoing embodiments described including at least the first six indices listed, regional indices, such as, but not limited to, indices based on North America, Europe, and the Pacific Rim. In still other embodiments include sector indices; for example, financials, durable goods, and mining sectors, among others as will be understood by those having ordinary skill in the art. The sectors could be based on a division of a country's index, or a division of a regional or world index, e.g., the U.S. (country), sectors within Europe (region), or just sectors no matter where they are located geographically (world).

The creation and provision of such indices can be accomplished by those having ordinary skill in the art; examples of sources capable of producing such indices include MSCI (New York, N.Y.). For example and not limitation, the exchange could include dozens of country, regional, and world indices from a company such as MSCI. In addition other providers having similar country, regional, and world indices can be used instead of, or in addition to, those provided by MSCI. Indeed, an array of indices from such single source providers can used in the present invention as well, as will be apparent to those having ordinary skill in the art. Novel indices can also be created using methods known to those having ordinary skill in the art. However, market acceptance may be easier if the indices from the most followed benchmarks in the world are used.

In one embodiment, the computers are further configured to provide electronically exchange operations substantially continuously, i.e., exchange operations are substantially 24 hours each day, five business days each week, 52 weeks each year. Such configurations and operations can be accomplished by those having ordinary skill in the art. Still other operational schedules will be apparent to those having ordinary skill in the art. Thus, the present invention provides a single exchange that is open nearly continuously for world-wide trading using standardized indices, thereby creating the first truly global equities exchange.

In another embodiment, the computer-implemented financial exchange provided by the invention includes the attributes just described above in addition providing the instruments in share-sized units. As used herein unless otherwise noted, “share-sized units” refers to numbers that are approximately similar in value to those commonly used in equity trades. For example, stocks in the U.S. typically trade in the range of $10 to $200 per share. Of course, the price of a company can move outside of that range. However, when a company's share price moves outside of the typical trading range, the company often will act to bring the stock price back within the trading range. For example, if the price exceeds the trading range, then the company will do a stock split, say, issuing double the number of shares, which forces share price to consequently begin trading at prices approximately half of the pre-split price. Such a split it typically initiated by the company when their stock price exceeds $200 for an extended period. Conversely, if the share price falls below the trading range, then the company will act to raise the stock price, e.g., by buying back its own stock or executing a reverse split by cutting the number of shares outstanding, say, in half; this will cause the price of the shares to start trading at roughly double the pre-split price. Such an action is typically initiated by the company when their share price drops below $10 for an extended period. Similarly to traditional equity, financial instruments described in the above-incorporated '687 application that trade in share-sized instruments will also typically trade in the range of $10 to $200. This can be accomplished easily because the underlying index will be reset or normalized to 100 each year end (explained further below), implying a near $100 instrument price at the beginning of the year, and barring any extremely abnormal events, would stay within the range of $10 to $200 in notional value throughout the year. In addition to the share-size price and normalized indices, instruments can be traded individually or in “blocks” of, e.g., 100, as these are common units of equity trades. Those having ordinary skill in the art will understand the scope and limits of “share-sized.”

In still another embodiment, the instruments described above are traded using a normalized price. “Normalized price” as used herein refers to prices that are set according to a standard methodology. Providing normalized prices will be understood by those having ordinary skill in the art. For example and not limitation, one approach takes all sector, country, regional, and world indices and “reset” or “normalize” to a price of 100 at 12:00 am on 1 January each year. The value will not be affected; only the index price will be changed. This is accomplished by adjusting each index by a multiplier that converts the index to a desired level. As a further example, if the Brazil index ended the year at 108.65, all one needs to do is multiply 108.038 by 0.9256 to get to 100. Every index would go through a similar exercise of multiplying the actual closing index on 31 Dec by a multiplier such that the result is 100. In this way, the year starts anew with all indices at 100. Of course, the result of the normalization could be any number, not just 100. Still other methods for normalizing prices as just described will be apparent to those having ordinary skill in the art.

Another interesting implication of normalizing (or “resetting”) all indices each year is that it makes spread trading very easy. For example, if one wants to spread trade with the current set of derivative instruments (long one country's index derivative and short another country's index derivative) it is certainly possible that such a position would need to be traded in huge size, because of the large and non-normalized notional contract values between the two. If, for example, one futures contract traded at a notional value of $73,460 and another futures contract traded at a notional value of $89,215, how could one possibly sell one and buy the other as an equal-dollar spread with no long or short bias? If one did so with just one contract of each, it is easy to see that $15,755 would not be part of the “spread” but would be outright long or short depending on which one was sold and which one was bought. To alleviate that problem, one could trade, in this case, approximately 73 contracts of the $89,215 futures and 89 contracts of the $73,460 futures. However, this severely limits the number of participants that have the desire and capital resources to trade a single spread in roughly $6.5 million minimum-size increments. To alleviate this issue, having all indices reset to 100 each year means the mismatch between indices would be small or an exact match may be within the trader's budget. For example, if one index were trading at 100 and another at 102, buying one at $100 and selling one at $102 means there is a $2 mismatch. However, even this “small” mismatch could be an issue if the trader needed a spread of, say, $5,000 on each side. However, in this case, instead of executing 50 contracts of each and now having a $100 mismatch, the trader could buy 50 of the $100 instruments and sell 49 of the $102 instruments. Even though the size increased 50 times, he was able to keep the mismatch to only $2.

Returning to the discussion of embodiments of the WIX, another embodiment includes, in addition to the foregoing elements described above, electronic representations of associated option or realized volatility instruments, or both. The creation of such instruments and their electronic representations in accordance with the disclosure herein will be understood by those having ordinary skill in the art. In more particular embodiments, the associated option or realized volatility instruments, or both are those provided under the registered trademarks VALSHARES®, VOLSHARES®, and VOLCONTRACT®, which are described in greater detail below.

In some embodiments, in addition to providing a normalized price the present invention includes periodic revisions to the normalized price. In more specific embodiments, the normalized price is revised yearly. Providing such revisions will be apparent to those having ordinary skill in the art.

By way of discussion and not limitation, no matter what index methodology is used, and even if all indices start at the same value, after a period of time the specific country indices could all have drastically different index values; this is because the stock prices and weightings of the individual securities that are used to create the index will vary over time. For example, and without limitation, it is certainly possible that given a few years of index calculation a China index could drastically outperform, say, a Libya index. After a while, therefore, one index may be at a level of, say, 5,000 while the other may be at, say, 5. Of course, when one compares percentage changes each day, each month, or each year, the level of the index does not really affect anything at all. However, on an exchange, derivative instruments are settled to the price values of the indices, not the percentage returns of the indices. In this case, it makes a large difference if one index value is 5,000 and another is 5. Of course, one could adjust the “multiplier” (the value used to multiply the raw index in order to create a “reasonable” size contract). In other words, if it is deemed that most market participants would prefer a contract size of $10,000, it is easy to see that the exchange could just deem the China contract to have a multiplier of $2 times the China index, and the Libya contract to have a multiplier of $2,000 times the Libya index; in this manner, both contracts would have the same initial $10,000 contract size. (All dollar amounts are in U.S. dollars unless otherwise noted, but the example can be cast in any base currency by analogy.) However, this creates problems too: the multiplier would require periodic adjustments to account for changes in the underlying economic factors of the index in question. For example, if the Libya index were to suddenly double because of some outstanding news, then the contract sizes would no longer be comparable. Thus, re-adjusting the multiplier would force market participants to perform more work: they would need to continually reference the multiplier to determine the contract size and to keep the value updated with any changes. If the exchange adjusted the index periodically, then the multiplier could remain constant and market participants would always know the approximate size of the instrument.

To address the above-described concerns, the present invention includes embodiments that provide computer-implemented financial exchanges configured to trade the instruments described in co-pending U.S. patent applications Ser. Nos. 12/983,851 and 13/074,687, the entire contents of each of which is incorporated herein by reference in its entirety and for all purposes. In more particular embodiments, the instruments are those sold under the trademark VALSHARES® by The Valuation Exchange Corporation (Gillette, N.J.). As described in more detail in the aforementioned and incorporated '851 and '687 applications, VALSHARES® instrument is a unique hybrid derivative instrument that takes the “best” features from equity, futures, and options and incorporates them all into one instrument. In many respects, the VALSHARES® has the look of, and trades like, a share of stock; however, it has features from futures, for example it expires. Essentially, the VALSHARES® instrument removes the burden of creating an instrument that represents ownership in an entity. Doing so opens up the field to a host of interesting assets, indices, formulas, or even measurements values that other instruments such as equities and exchange-traded funds (“ETFs”) cannot address.

As will be appreciated by those having ordinary skill in the art, one of the features of the VALSHARES® instrument is the lack of a multiplier. Thus, in still more particular embodiments, the index is scaled so that it is not too far out of the range of the typical transactions sizes that market participants are used to. In a still more particular embodiment, the index is based on a $100 per share price. In yet more particular embodiments, all indices are reset to 100 at the end of the last day of the year (calendar or otherwise defined), and the instruments, e.g., the VALSHARES® instruments, are reset to $100 per share and begin the period anew.

As will be appreciated also by those having ordinary skill in the art, embodiments such as these will enable market participants to see easily the year-to-date performance of each index, and clearly compare one index to another on the same year-to-date basis. Of course, the month-to-month, quarter-to-quarter, and year-to-year figures would still need to be calculated, if that is of interest to the trader; but, the year-to-date performance, one of the most popular metrics, would just “drop out” of the comparison of index prices at any time.

In another embodiment, the WIX provided by the present invention is configured to provide and trade instruments based on realized volatility. In a more particular embodiment, the realized volatility instruments are those described in U.S. Pat. No. 7,328,184, which is incorporated herein by reference in its entirety and for all purposes. Still other embodiments of the present invention include instruments described in the above-incorporated '851 and '687 applications that are used in conjunction with the instruments described in the '184 patent to create an instrument that appeals to equity- and equity-options investors. As will be understood by those having ordinary skill in the art, such an instrument will trade like a share of stock, similar to VALSHARES®, but there are two differentiating factors: first the value of VOLSHARES® is based on a realized volatility formula as defined in the '184 patent; second, expiration would not be on a yearly schedule, but would coincide with options expiration dates. Therefore, if the current schedule of options remain the same, there would be monthly and quarterly expiration dates to VOLSHARES®. Weekly or daily expiration dates for VOLSHARES® can also be used in the future as the current trend of listing shorter-time-frame instruments continues toward the ultimate end of providing daily expirations.

In some embodiments the computer-implemented exchange of the invention is configured to use a single base currency. In other embodiments, the computer-implemented exchange of the invention includes instruments configured to reduce or eliminate currency risk of financial instruments. Again by way of discussion and not limitation, derivative instruments known generically as “Quanto FX” instruments eliminate the currency risk associated with cross-boarder assets. For example, if one wanted to invest in the 225 stocks that make up the Japanese Nikkei 225 stock index from the United States, an investor would first send dollars to Japan and convert them to yen. With the yen, he or she would then buy the 225 stocks that make up the index. Assuming that the investor holds the stock portfolio for one year and if the stocks that comprise the portfolio rise 10% in that year, then the investor will believe that he or she just made 10%. However, if those funds are needed back in the home country of the U.S., the shares would be liquidated, and the investor would receive yen for the stock sale. He or she then sends the yen back to the U.S. and converts the currency along the way. If the value of the U.S. dollar, say, lost 5% of its value over the year, then the investor ends up with only a 5% net gain (10% gain from the equity, but a 5% loss from the currency conversion).

To alleviate this risk, in some embodiments the above-described VALSHARES® instruments are defined in a way that eliminates the currency risk. In a more specific exemplary embodiment, the price of a VALSHARES® instrument on the Nikkei 225 index is based in “local” terms (as if a Japanese investor were already investing in yen). However, while the index is in local terms, the currency used is in, say, U.S. dollars. In this way, if the index rose 10%, a U.S. investor would get a 10% rise and not have to worry about the currency risk taking away half of that gain (as in our prior example). Of course, the above illustration is based on a U.S. investor perspective. This example could easily be accomplished with any other base currency or with any other country index. Nothing in the above should be construed to limit the “home” or “investing” currency.

Additional embodiments of the invention include computer-implemented financial exchanges that comprise a plurality of computers in electronic communication, which computers are configured to generate and trade electronically electronic representations of instruments on a set of representative global equity indices based on a single source; the computer-implemented financial exchange being further configured to provide electronically exchange operations substantially continuously, as described herein, in addition to being configured to conduct trades using a single base currency and to provide electronically instruments in share-sized units. In other embodiments, the instruments are traded at a normalized price also as described herein. Furthermore, the instruments include associated option or realized volatility instruments, or both and the normalized price is revised periodically again, as described herein. In still more particular additional embodiments, the associated option or realized volatility instruments, or both are VALSHARES®, VOLSHARES®, and VOLCONTRACT® instruments.

Still more additional embodiments of the invention include computer-implemented financial exchanges that comprise a plurality of computers in electronic communication, which computers are configured to generate and trade electronically electronic representations of instruments on a set of representative global equity indices based on a single source, and further to provide electronically exchange operations substantially continuously, as described herein, and include one or more of the additional embodiments, features, and aspects described hereinabove.

In a second aspect, the present invention provides a computer-implemented method for operating a computer-implemented financial exchange. In one embodiment, the method provided by the invention comprises providing electronically users of the computer-implemented financial exchange with computer-implemented financial exchange with electronically traded electronic representations of instruments on a set of representative global equity indices based on a single source as described above, and providing electronically operations for the computer-implemented financial exchange substantially continuously as described above. The details for implementing these actions will be familiar to those having ordinary skill in the art.

In a more detailed embodiment, the method just described further includes providing electronically the instruments in share-sized units. In another embodiments, the invention includes providing electronically operations for the computer-implemented financial exchange substantially continuously as described above, and trading the instruments using a normalized price as described above. A still more detailed embodiment further includes providing electronically associated option or realized volatility instruments, or both as described above; and in a yet more detailed embodiment the instruments are VALSHARES®, VOLSHARES® and VOLCONTRACT® instruments. The details for implementing these actions will be familiar to those having ordinary skill in the art as guided by the present description.

In another embodiment, the computer-implemented method of the invention comprises providing electronically users of the computer-implemented financial exchange with electronically traded electronic representations of instruments on a set of representative global equity indices based on a single source as described above, providing electronically operations for the computer-implemented financial exchange substantially continuously as described above, and further comprises normalizing the price periodically, also as described above. In a more specific embodiment, the price in normalized yearly. The details for implementing these actions will be familiar to those having ordinary skill in the art as guided by the present description.

In still another embodiment, the computer-implemented method of the invention comprises providing electronically users of the computer-implemented financial exchange with electronically traded electronic representations of instruments on a set of representative global equity indices based on a single source as described above, providing electronically operations for the computer-implemented financial exchange substantially continuously as described above, and further comprises receiving electronically information related to trades of the instruments listed on the exchange. In other embodiments, the method further comprises sending electronically information related to trades of the instruments listed on the exchange. In still other embodiments, the method of the invention further comprises receiving electronically information related to the indices. And in yet other embodiments, the method of the invention further comprises sending electronically information related to the indices. The details for implementing these actions will be familiar to those having ordinary skill in the art as guided by the present description.

In another embodiment, the computer-implemented method of the invention comprises providing electronically users of the computer-implemented financial exchange with electronically traded electronic representations of instruments on a set of representative global equity indices based on a single source as described above, providing electronically operations for the computer-implemented financial exchange substantially continuously as described above, and further comprises conducting electronically the trades using a single base currency. The details for implementing these actions will be familiar to those having ordinary skill in the art as guided by the present description.

In yet another embodiment, the computer-implemented method of the invention comprises providing electronically users of the computer-implemented financial exchange with instruments from a single source as described above, providing electronically operations for the computer-implemented financial exchange substantially continuously as described above, and further comprises conducting electronically the trades using a single base currency and providing electronically instruments in share-sized units as described above. In other embodiments, the instruments are traded at a normalized price as described above. In still other embodiments, the instruments include associated option or realized volatility instruments, or both. The details for implementing these actions will be familiar to those having ordinary skill in the art as guided by the present description.

In another aspect, the present invention provides an electronic computer configured to operate on a computer-implemented financial exchange in electronic communication with such exchange, the electronic computer comprising: electronic instructions and data configured to provide users of the computer-implemented financial exchange with electronically traded electronic representations of instruments on a set of representative global equity indices based on a single source as described above, and allow electronic trading on the computer-implemented financial exchange substantially continuously as described above. The details for implementing these actions will be familiar to those having ordinary skill in the art as guided by the present description.

In another embodiment, the electronic computer just described further comprises electronic instructions and data encoding share-sized instruments as described above. In a more specific embodiment the electronic instructions and data are configured to enable electronic trading of the share-sized instruments. In another embodiment, the instruments are traded using a normalized price. The details for implementing these actions will be familiar to those having ordinary skill in the art as guided by the present description. In a more specific embodiment, the electronic instructions and data for the instruments includes electronic instructions and data encoding associated option or realized volatility instruments, or both as described above; in a still more specific embodiments, the associated option or realized volatility instruments, or both are VALSHARES®, VOLSHARES® and VOLCONTRACT® instruments as described above.

Other specific embodiments of the invention include an electronic computer configured to operate on a computer-implemented financial exchange in electronic communication with such exchange, the electronic computer comprising: electronic instructions and data configured to provide users of the computer-implemented financial exchange with electronically traded electronic representations of instruments on a set of representative global equity indices based on a single source as described above, and allow electronic trading on the computer-implemented financial exchange substantially continuously as described above, wherein the normalize price is a periodically revised normalized price as described above; and in still more specific embodiments, the normalized price is revised yearly as described above. The details for implementing these actions will be familiar to those having ordinary skill in the art as guided by the present description.

Still other more specific embodiments include an electronic computer configured to operate on a computer-implemented financial exchange in electronic communication with such exchange, the electronic computer comprising: electronic instructions and data configured to provide users of the computer-implemented financial exchange with electronically traded electronic representations of instruments on a set of representative global equity indices based on a single source as described above, and allow electronic trading on the computer-implemented financial exchange substantially continuously as described above, wherein the electronic instructions and data further include electronic instructions and data configured to enable the electronic computer to conduct electronically the trades using a single base currency. The details for implementing these actions will be familiar to those having ordinary skill in the art as guided by the present description.

Yet more specific embodiments include an electronic computer configured to operate on a computer-implemented financial exchange in electronic communication with such exchange, the electronic computer comprising: electronic instructions and data configured to provide users of the computer-implemented financial exchange with electronically traded electronic representations of instruments on a set of representative global equity indices based on a single source, and allow electronic trading on the computer-implemented financial exchange substantially continuously as described above, wherein the electronic instructions and data further include electronic instructions and data configured to enable the electronic computer to conduct electronically the electronic trading using a single base currency, to provide electronically instruments in share-sized units. In another embodiment, the instruments are traded at a normalized price. In still another embodiment, the instruments include associated option or realized volatility instruments, or both. The details for implementing these actions will be familiar to those having ordinary skill in the art as guided by the present description.

In still another aspect, the present invention provides a computer-readable medium containing computer-readable electronic program control devices thereon, comprising: computer-readable electronic program control devices configured to enable an electronic computer to operate on a computer-implemented financial exchange in electronic communication with such exchange, and computer-readable electronic program control devices encoding electronic instructions and data configured to provide users of the computer with electronically traded electronic representations of instruments on a set of representative global equity indices based on a single source, and allow electronic trading using the computer on the computer-implemented exchange substantially continuously. The details of such instructions and operations are described above. In a more specific embodiment, the electronic instructions and data include electronic instructions and data encoding share-sized instruments. In another embodiment, the electronic instructions and data are further configured to enable electronic trading of instruments using a normalized price as described above. In still more specific embodiments, the electronic instructions and data for the instruments includes electronic instructions and data encoding associated option or realized volatility instruments, or both; and in yet more specific embodiments, the associated option or realized volatility instruments, or both are VALSHARES®, VOLSHARES® and VOLCONTRACT® instruments. The details for implementing these actions will be familiar to those having ordinary skill in the art as guided by the present description.

In other embodiments, the computer-readable electronic program control devices encode electronic instructions and data that are configured to provide users of the computer with electronically traded electronic representations of instruments on a set of representative global equity indices based on a single source, and allow electronic trading using the computer on the computer-implemented exchange substantially continuously, and in which the electronic instructions and data include electronic instructions and data encoding share-sized instruments. In another embodiment, the electronic instructions and data are configured to enable electronic trading using a normalized price as described above; in still more specific embodiments, the normalized price is a periodically revised normalized price as described above; and, still more specifically, the normalized price is a yearly revised normalized price as described above. The details for implementing these actions will be familiar to those having ordinary skill in the art as guided by the present description.

In other embodiments, the computer-readable electronic program control devices encode electronic instructions and data that are configured to provide users of the computer with electronically traded electronic representations of instruments on a set of representative global equity indices based on a single source, and allow electronic trading using the computer on the computer-implemented exchange substantially continuously, the electronic instructions and data further include electronic instructions and data configured to enable the electronic computer to conduct electronically the trades using a single base currency as described above. The details for implementing these actions will be familiar to those having ordinary skill in the art as guided by the present description.

In other embodiments, the computer-readable electronic program control devices encode electronic instructions and data that are configured to provide users of the computer with electronically traded electronic representations of instruments on a set of representative global equity indices based on a single source, and allow electronic trading using the computer on the computer-implemented exchange substantially continuously, the electronic instructions and data further include electronic instructions and data configured to enable the electronic computer to conduct electronically the electronic trading using a single base currency, to provide electronically instruments in share-sized units. In still another embodiment, the instruments are traded at a normalized price; in more specific embodiments, the normalized price is revised periodically as described above. In still another embodiment the instruments include associated option or realized volatility instruments, or both. The details for implementing these actions will be familiar to those having ordinary skill in the art as guided by the present description.

Applying the discussion above, several exemplary embodiments will be described. In one example, WIX lists country indices from all, or most, of the developed countries in the world, such as, but not limited to, US, Canada, German, UK, France, Japan, Australia, etc. In another example, the exchange also lists “regional” indices that combine country indices with close economic ties, such as North America combining US and Canada, and Mexico. In a third example, similar indices are created for emerging markets by listing indices from countries such as Brazil, Turkey, India, etc., and then combining them into regions such as South America, Emerging Asia, etc. After providing a panoply of indices as just described, the indices are denominated in the local currency or in a single base currency, such as U.S. dollars. Those having ordinary skill in the art will understand that by listing the local currency version as the underlying index but settling the financial instrument in another currency, say, U.S. dollars, currency risk is eliminated.

Another feature of the invention that market participants will find useful is “resetting” or “normalizing” all of the indices to the same value, such as 100, on 1 January each year; this helps keep spread trades in the same units and allows for easy comparison of which index is outperforming or underperforming its peers on a year-to-date basis. Providing share-sized derivative contracts also helps the market take an outright position or spread position in small size. Having a single platform that is open almost continuously (approximately 23 hours per day on business days) will aid transactions and allow for cross margining. Finally, adding options and volatility instruments to the mix brings in other market participants and aids in spreading and arbitrage.

### 3.2 Summary of Features and Advantages of the Invention

As those having ordinary skill in the art will understand from the foregoing discussion, the invention's feature of normalizing the share price periodically, e.g., at the start of a year, offers several important advantages for participants in the WIX:
Small size to attract the most market participants;
Easy matching of spread size because of small size instruments;
Easily determination of the year-to-date performance of any normalized index;
Easy comparison of the relative performance of any normalized index to its peers; and
Near-constant units of investment.

Portfolio managers who invest internationally are usually benchmarked to country, regional, and global indices with consistent methodologies. Yet, the current state of popular (i.e., liquid) equity derivative indices is anything but consistent. Hence performance of an international portfolio when using derivatives is often mismatched from the portfolio manager's benchmark.

A single platform, open nearly 24 hours every business day (apart from suspending operations for maintenance), would foster spreads and relative-value trading. Currently, it may not be possible to spread, say, a European country index with an Asian index, because the exchanges are open at completely different times. The only way a spread could be initiated would be to “leg in” (executing one side at a time). However, doing so exposes the trader to directional risk until the second leg can be established. Most spread traders are not willing to take directional exposure at any time. This means that the current methodology of trading spreads globally is nonexistent because not all exchanges are open around the clock. In addition, margin requirements are a major cost factor with the current system of disparate exchanges. Most exchanges do not recognize the positions held at other, competing exchanges; this means that a long position established at one exchange with a short position established at another often cannot be cross margined. Cross margining is a very desirable feature because spreads are often less risky than outright long or short positions. Having all traded instruments on one exchange allows for this possibility of reducing capital outlay costs for reduced risk positions.

One of the features of VALSHARES® is that they expire annually instead of quarterly. Many stock traders invest for much longer periods than typical futures traders. Having an instrument that expires quarterly, as is currently the case with futures on equity indices, reduces the pool of potential traders, because of the hassle and cost of rolling open positions quarterly. A yearly roll more closely corresponds to the horizon of many portfolio managers, and hence, a yearly expiration would not be a burden or impediment to their participation, but would come with the benefit of reduced roll costs by 75%.

It should be noted that expiration is a process that forces the instrument to converge to the underlying. Without this feature, VALSHARES® could trade at any level. Market participants would quickly lose interest for fear that the instrument could mistrack the underlying. However, because of expiration, arbitragers, by their very action of trading on any mispricing, force the markets toward their theoretical value.

Having a single base currency not only saves transacting costs, but the majority of international equity portfolio managers are not currency experts. They sometimes hedge all currency risks (incurring a lot of costs), and they sometimes do not hedge at all (leaving the portfolio exposed to currency fluctuations). However, it is rare to find international portfolio managers who have strong opinions or understanding of currency markets in order to take an active position in the various currencies, in addition to their equity allocation, around the globe. Having an instrument that eliminates this risk also appeals to the majority of market participants in international equity indexing.

As mentioned above, spreading and arbitrage among “all” countries is currently not possible because the exchanges are open at different times around the globe. Placing these country, regional, and world indices on one platform would enable a large group of market participants to spread trade who are currently shut out of such transactions. However, because of the large notional size issue among current equity index futures, even that step of consolidation and bringing various equity index futures onto one platform would not be as effective as it may appear to be on the surface; this is because of the spread mismatch that was discussed earlier. The normalization of the indices on a yearly basis is the other key feature that could finally bring all of these market participants to the market and be able to trade in just about any size desired.

Using a single base currency for all equity indices substantially removes the initial, follow-up, and liquidation costs of currency hedges. These hedges can be costly because periodically, the hedges need to be rebalanced to match the increase or decrease in exposure from changes to the equity index. All of these follow-up transactions are costly. The bottom line is that the initial, follow-up rebalancing, and liquidation costs of foreign currency transactions are completely, or nearly completely, eliminated with a quanto derivative instrument. Such an instrument could save an international investor substantial currency transaction costs.

VALSHARES® expire once each year. Almost all financial futures expire quarterly. The use of VALSHARES® could save longer-term investors 75% of the transaction cost to “roll” from one contract to another, plus more if the prices received in the transaction are not exactly the theoretically correct value.

The present invention also allows for reduced broker fees for larger investors. In the futures markets, typically broker fees are per contract, which provides no discount for larger orders. In the securities industry, typically there is a scheduled broker fee reduction based on the size of the order. As will be appreciated by those having ordinary skill in the art, using a securities-like format for a financial instrument may enable the market to demand a securities-like price structure as well.

Normalizing the share price each year keeps investment size roughly constant. While this is not a cost savings feature per se, it keeps costs-per-investment-unit to a near constant allowing for portfolio managers to project transaction costs much more accurately.

Consolidation of equity index trading onto a single platform globally can enhance market integrity while reducing the performance bond requirement and making for increased capital efficiencies. Such a platform would open up spread trading in country pairs that currently have no, or small windows of, overlapping periods for simultaneous execution.

The ability to include volatility trading as described herein can also help enhance capital efficiencies. Since one of the components of portfolio risk is the potential of prices changing, a VOLCONTRACT® or VOLSHARES® could be used to offset some of those risks. Portfolio managers could take a position in VOLCONTRACT® or VOLSHARES® instruments to offset some of those risks, thereby boosting capital efficiencies and protecting the portfolio from adverse drops in value.

### 3.3 Implementation

The invention described herein can be implemented in digital electronic circuitry, or in computer hardware, firmware, software, or in combinations thereof. Data on the investment instruments described herein, generation, trading, and settling of such instruments and their trades, the creation and maintenance of indices, and other relevant information is stored, manipulated, and transmitted using such digital electronic circuitry, or in computer hardware, firmware, software, or in combinations thereof. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on programmable systems including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks.

Storage devices suitable for tangibly embodying computer program instructions and data described herein include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits). All of these are referred to herein generally as “computer-readable media containing computer-readable program control devices.”

To provide for interaction with a user, the invention can be implemented on a computer system having a display device such as a monitor or LCD screen for displaying information in conjunction with the inversion to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor can be coupled to a computer or telecommunications network, for example, an Internet network, or an intranet network, using a network connection, through which the processor can receive information from the network, or might output information to the network in the course of performing the above-described method steps. Such information, which is often represented as a sequence of instructions to be executed using the processor, can be received from and output to the network, for example, in the form of a computer data signal embodied in a carrier wave. The above-described devices and materials will be familiar to those of skill in the computer hardware and software arts.

It should be noted that the present invention employs various computer-implemented operations involving data, in particular data described above in conjunction with the invention, stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

The present invention also relates to devices, systems or apparatus for performing the aforementioned operations. The system can be specially constructed for the required purposes, or it can be a general-purpose computer selectively activated or configured by a computer program stored in the computer. The processes presented above are not inherently related to any particular computer or other computing apparatus. In particular, various general-purpose computers can be used with programs written in accordance with the teachings herein, or, alternatively, it can be more convenient to construct a more specialized computer system to perform the required operations.

### 4 Conclusion

Thus, as those having ordinary skill in the art will appreciate, the present invention solves the problems described above. Without wishing to be bound to any theory of action, in particular the problem with the various “locally-grown” indices in countries around the world is that they all have different methodologies. Companies like MSCI, Nasdaq, Dow Jones, and Financial Times have addressed these shortcomings by introducing sector, country, regional, and world equity indices spanning the globe using a consistent methodology; this consistent methodology is the key to international portfolio managers' performance metrics. But while it is possible to find a portfolio manager who benchmarks himself to the local index, such as the S&P 500 in the U.S., the Dax in Germany, and the Nikkei in Japan, most portfolio managers are benchmarked to indices created by one of the aforementioned companies, such as MSCI U.S., MSCI Germany, and MSCI Japan, there remains a mismatch or inefficiency that the present invention addresses: international portfolio managers are most often benchmarked to a single source, but the index futures trading around the globe are not. Therefore, it is not easy to establish a position in the country's equity index futures and keep pace with the single-source benchmark, potentially leading to an undesirable deviation in performance. Listing equity indices from a single source virtually guarantees that the desired exposure is tracked exactly or extremely closely. To date, no exchange lists the panoply of sector, country, regional, and world equity indices from a single source on one exchange. In addition, placing many, most, or all such indices on one exchange opens a host of desirable features and cost saving elements as will be shown in the following pages.

A number of implementations of the invention have been described. Nevertheless, it will be understood that various modifications can be made without departing from the spirit and scope of the invention. Accordingly, other embodiments are within the scope of the following claims.

What is claimed:

1. A computer-implemented financial exchange, comprising: a plurality of computers in electronic communication, said computers being configured to generate and trade electronically electronic representations of instruments on a set of representative global equity indices based on a single source; and said computer-implemented financial exchange being further configured to provide electronically exchange operations substantially continuously.

2. The computer-implemented financial exchange of claim 1, wherein said computer-implemented exchange is configured to provide electronically said electronic representations of instruments in share-sized units.

3. The computer-implemented financial exchange of claim 1, wherein said computer-implemented exchange is configured to trade electronically said electronic representations of instruments a normalized price.

4. The computer-implemented financial exchange of claim 3, wherein said electronic representations of instruments include electronic representations of associated option or realized volatility instruments, or both.

5. The computer-implemented financial exchange of claim 4, wherein said associated option or realized volatility instruments, or both are VALSHARES®, VOLSHARES® and VOLCONTRACT® instruments.

6. The computer-implemented financial exchange of claim 3, wherein said computer-implemented exchange is configured to revise electronically said normalized price to provide thereby a revised normalized price.

7. The computer-implemented financial exchange of claim 6, wherein said normalized price is revised yearly.

8. The computer-implemented financial exchange of claim 1, wherein said computer-implemented financial exchange is configured to conduct electronically said trades using a single base currency.

9. The computer-implemented financial exchange of claim 1, wherein said computer-implemented financial exchange is configured to conduct electronically said trades using a single base currency and to provide electronically electronic representations of instruments in share-sized units at a normalized price, and wherein said electronic representations of instruments include electronic representations of associated option or realized volatility instruments, or both and said normalized price is revised periodically.

10. The computer-implemented financial exchange of claim 9, wherein said associated option or realized volatility instruments, or both are VALSHARES®, VOLSHARES® and VOLCONTRACT® instruments.

11. A computer-implemented method for operating a computer-implemented financial exchange, comprising providing a plurality of computers in electronic communication, said computers providing electronically users of said computer-implemented financial exchange with electronically traded, electronic representations of instruments on a set of representative global equity indices based on a single source; and said computers providing electronically operations for said computer-implemented financial exchange substantially continuously.

12. The computer-implemented method of claim 11, further comprising providing electronically said electronic representations of instruments in share-sized units.

13. The computer-implemented method of claim 11, further comprising trading said electronic representations of instruments using a normalized price.

14. The computer-implemented method of claim 13, further comprising providing electronically electronic representations of associated option or realized volatility instruments, or both.

15. The computer-implemented method of claim 14, wherein said instruments are VALSHARES®, VOLSHARES® and VOLCONTRACT® instruments.

16. The computer-implemented method of claim 11, further comprising normalizing said price periodically.

17. The computer-implemented method of claim 16, further comprising normalizing said price yearly.

18. The computer-implemented method of claim 11, further comprising receiving electronically information related to trades of said electronic representations of instruments listed on said exchange.

19. The computer-implemented method of claim 11, further comprising sending electronically information related to trades of said electronic representations of instruments listed on said exchange.

20. The computer-implemented method of claim 11, further comprising receiving electronically information related to said indices.

21. The computer-implemented method of claim 11, further comprising sending electronically information related to said indices.

22. The computer-implemented method of claim 11, further comprising conducting electronically said trades using a single base currency.

23. The computer-implemented method of claim 11, further comprising conducting electronically said trades using a single base currency and providing electronically electronic representations of instruments in share-sized units at a normalized price, wherein said electronic representations of instruments include electronic representations of associated option or realized volatility instruments, or both and said normalized price is revised periodically.

24. An electronic computer configured to operate on a computer-implemented financial exchange in electronic communication with such exchange, said electronic computer comprising: electronic instructions and data configured to provide users of said computer-implemented financial exchange with electronically traded electronic representations of instruments on a set of representative global equity indices based on a single source; and allow electronic trading on said computer-implemented financial exchange substantially continuously.

25. The electronic computer of claim 24, wherein said electronic instructions and data include electronic instructions and data encoding share-sized electronic representations of said instruments.

26. The electronic computer of claim 24, wherein said electronic instructions and data are further configured to enable electronic trading of said electronic representations of said instruments using a normalized price.

27. The electronic computer of claim 26, wherein said electronic instructions and data for said electronic representations of instruments includes electronic instructions and data encoding electronic representations of associated option or realized volatility instruments, or both.

28. The electronic computer of claim 27, wherein said associated option or realized volatility instruments, or both are VALSHARES®, VOLSHARES® and VOLCONTRACT® instruments.

29. The electronic computer of claim 26, wherein said normalized price is a periodically revised normalized price.

30. The electronic computer of claim 29, wherein said normalized price is a yearly revised normalized price.

31. The electronic computer of claim 24, wherein said electronic instructions and data further include electronic instructions and data configured to enable said electronic computer to conduct electronically said trades using a single base currency.

32. The electronic computer of claim 24, wherein said electronic instructions and data further include electronic instructions and data configured to enable said electronic computer to conduct electronically said electronic trading using a single base currency, to provide electronically electronic representations of instruments in share-sized units at a normalized price, wherein said electronic representations of instruments include electronic representations of associated option or realized volatility instruments, or both and said normalized price is revised periodically.

33. A computer-readable medium containing computer-readable electronic program control devices thereon, comprising: computer-readable electronic program control devices configured to enable an electronic computer to operate on a computer-implemented financial exchange in electronic communication with such exchange, and computer-readable electronic program control devices encoding electronic instructions and data configured to provide users of said computer with electronically traded electronic representations of instruments on a set of representative global equity indices based on a single source; and allow electronic trading using said computer on said computer-implemented exchange substantially continuously.

34. The computer-readable medium of claim 33, wherein said electronic instructions and data include electronic instructions and data encoding electronic representations of share-sized instruments.

35. The computer-readable medium of claim 33, wherein and said electronic instructions and data are further configured to enable electronic trading of said electronic representations of instruments using a normalized price.

36. The computer-readable medium of claim 35, wherein said electronic instructions and data for said electronic representations of instruments includes electronic instructions and data encoding electronic representations of associated option or realized volatility instruments, or both.

37. The computer-readable medium of claim 36, wherein said associated option or realized volatility instruments, or both are VALSHARES®, VOLSHARES® and VOLCONTRACT® instruments.

38. The computer-readable medium of claim 35, wherein said normalized price is a periodically revised normalized price.

39. The computer-readable medium of claim 38, wherein said normalized price is a yearly revised normalized price.

40. The computer-readable medium of claim 33, wherein said electronic instructions and data further include electronic instructions and data configured to enable said electronic computer to conduct electronically said trades using a single base currency.

41. The computer-readable medium of claim 33, wherein said electronic instructions and data further include electronic instructions and data configured to enable said electronic computer to conduct electronically said electronic trading using a single base currency, to provide electronically electronic representations of instruments in share-sized units at a normalized price, wherein said electronic representations of instruments include electronic representations of associated option or realized volatility instruments, or both and said normalized price is revised periodically.
